(19) United States
(12) Patent Application Publication
(10) Pub. No.: US 2022/0194368 A1
(43) Pub. Date: Jun. 23, 2022

(54) COLLISION AVOIDANCE SYSTEM AND COLLISION AVOIDANCE METHOD

(71) Applicant: TOYOTA JIDOSHA KABUSHIKI KAISHA, Toyota-shi Aichi-ken (JP)

(72) Inventors: Kazuki Nemoto, Susono-shi Shizuoka-ken (JP); Shin Tanaka, Numazu-shi Shizuoka-ken (JP); Satoshi Nakamura, Susono-shi Shizuoka-ken (JP)

(73) Assignee: TOYOTA JIDOSHA KABUSHIKI KAISHA, Toyota-shi Aichi-ken (JP)

(21) Appl. No.: 17/494,365

(22) Filed: Oct. 5, 2021

(30) Foreign Application Priority Data
Dec. 23, 2020 (JP) 2020-213901

(51) Int. Cl. B60W 30/095; B60W 30/09; H04W 4/46; G06K 9/00; G08G 1/16

(52) U.S. Cl. CPC B60W 30/0956; B60W 30/09; H04W 4/46; G06K 9/00825; B60W 2554/20; G08G 1/166; B60W 2556/65; B60W 2554/4041; G08G 1/161

(57) ABSTRACT

A first vehicle includes: a communications device configured to transmit and receive V2V information; an acquisition device configured to acquire driving environment information; and a processing device configured to perform a collision determination process for a second vehicle as an oncoming vehicle. The second vehicle includes a communications device configured to transmit and receive V2V information. In the collision determination process, the processing device recognizes an object around the first vehicle based on the driving environment information. Further, the processing device determines whether or not the second vehicle has a collision risk to collide with the object, based on the driving environment information and the V2V information received from the second vehicle. When the second vehicle is determined to have the collision risk, alert information for the object is formed. The alert information is transmitted to the communications device of the second vehicle.

### CROSS-REFERENCE TO RELATED APPLICATION

This application claims priority to Japanese Patent Application No. 2020-213901 filed on Dec. 23, 2020, incorporated herein by reference in its entirety.

### BACKGROUND

### 1. Technical Field

The present disclosure relates to a system and a method for improving traveling safety of a second vehicle as a surrounding vehicle by use of communication (vehicle-to-vehicle communication and hereinafter also referred to as “V2V”) between a first vehicle as a host vehicle and the second vehicle.

### 2. Description of Related Art

Japanese Unexamined Patent Application Publication No. 2019-87076 (JP 2019-87076 A) describes a system including a plurality of vehicles traveling in a column and a server communicating with the vehicles individually. The server in this conventional system detects an abnormal vehicle from among the vehicles based on behavioral information on each vehicle. The detection of an abnormal vehicle is performed based on statistics processing on the behavioral information. When an abnormal vehicle is detected, the server specifies an abnormal part based on behavioral information on the abnormal vehicle, the behavioral information being received from a normal vehicle traveling ahead of or behind the abnormal vehicle. The specification of an abnormal part may be performed by use of V2V between the abnormal vehicle and the normal vehicle. When the abnormal part is specified, the server provides information on the abnormal part to the abnormal vehicle or the normal vehicle.

### SUMMARY

The information on the abnormal part is information that is useful for the abnormal vehicle and the normal vehicle. In the conventional system, such information is provided via the server.

In view of this, when a host vehicle is regarded as a first vehicle and a surrounding vehicle is regarded as a second vehicle, it is considered that useful information for the second vehicle is provided to the second vehicle by V2V between the first vehicle and the second vehicle. Particularly, information indicating that the second vehicle is in danger from colliding with an object recognized by the first vehicle, and it is desirable that the information be provided to the second vehicle actively.

One object of the present disclosure is to provide a technology that can improve traveling safety of a second vehicle as a surrounding vehicle by use of V2V between a first vehicle as a host vehicle and the second vehicle.

A first disclosure is a collision avoidance system using communication between a first vehicle and a second vehicle and has the following feature. The first vehicle includes a communications device, an acquisition device, and a processing device. The communications device is configured to transmit and receive vehicle-to-vehicle communication information. The acquisition device is configured to acquire driving environment information on the first vehicle. The processing device is configured to perform a collision determination process for the second vehicle. The second vehicle includes a communications device configured to transmit and receive vehicle-to-vehicle communication information. The collision determination process is performed as follows. The processing device recognizes an object around the first vehicle based on the driving environment information. The processing device determines whether or not the second vehicle has a collision risk to collide with the object, based on the driving environment information and the vehicle-to-vehicle communication information received from the second vehicle. When the processing device determines that the second vehicle has the collision risk, the processing device transmits alert information for the object to the communications device of the second vehicle via the communications device of the first vehicle.

A second disclosure has the following feature in addition to the first disclosure. The second vehicle may further include a control device configured to perform a travel control on the second vehicle. The alert information may include information on a target deceleration for the second vehicle to avoid a collision with the object. The control device may perform an emergency deceleration control on the second vehicle based on the target deceleration as the travel control.

A third disclosure has the following feature in addition to the first or second disclosure. The collision determination process may be performed as follows. That is, the processing device may recognize a static object on a lane where the second vehicle is traveling, based on the driving environment information. Based on at least either of the driving environment information and the vehicle-to-vehicle communication information received from the second vehicle, the processing device may predict a future trajectory of the second vehicle and determines whether or not the future trajectory passes a recognized position of the static object. When the processing device determines that the future trajectory passes the recognized position, the processing device may calculate a time-to-collision of the second vehicle to the recognized position. When the time-to-collision is a threshold or less, the processing device may determine that the second vehicle has the collision risk.

A fourth disclosure has the following feature in addition to the first or second disclosure. The collision determination process may be performed as follows. The processing device may recognize a dynamic object on a lane where the second vehicle is traveling or outside the lane, based on the driving environment information. Based on at least either of the driving environment information and the vehicle-to-vehicle communication information received from the second vehicle, the processing device may predict future trajectories of the dynamic object and the second vehicle and determines whether the future trajectories intersect with each other or not. When the processing device determines that the future trajectories intersect with each other, the processing device may calculate a time-to-collision of the second vehicle to an intersection position between the future trajectories. When the time-to-collision is a threshold or less, the processing device may determine that the second vehicle has the collision risk.

A fifth disclosure is a collision avoidance method using communication between a first vehicle and a second vehicle and has the following feature. The second vehicle is an oncoming vehicle traveling ahead of the first vehicle in a direction opposite to an advancing direction of the first vehicle. The collision avoidance method includes: acquiring, by a processing device of the first vehicle, driving environment information on the first vehicle; recognizing, by the processing device, an object around the first vehicle based on the driving environment information; determining, by the processing device, whether or not the second vehicle has a collision risk to collide with the object, based on the driving environment information and vehicle-to-vehicle communication information received from the second vehicle; and when the processing device determines that the second vehicle has the collision risk, transmitting, by the processing device, alert information for the object to a communications device of the second device via a communication device of the first device.

With the first or fifth disclosure, it is determined whether or not the second vehicle has a collision risk to collide with an object around the first vehicle, based on the driving environment information on the first vehicle and the V2V information received from the second vehicle. When the second vehicle is determined to have the collision risk, alert information for the object is transmitted to the communications device of the first vehicle. The alert information transmitted to the communications device of the first vehicle is transmitted to the communications device of the second vehicle by V2V. This can improve traveling safety of the second vehicle. As a result, traveling safety of the first vehicle can be improved.

With the second disclosure, in a case where the alert information includes information on the target deceleration for the second vehicle, it is possible to perform an emergency deceleration control on the second vehicle based on the target deceleration. The emergency deceleration control enables to avoid a collision between the second vehicle and an object having a collision risk to collide with the second vehicle.

With the third or fourth disclosure, it is possible to highly precisely calculate a collision risk between the object around the first vehicle and the second vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an example of V2V performed by a collision avoidance system according to an embodiment;

FIG. 2 is a view illustrating another example of V2V performed by the collision avoidance system;

FIG. 3 is a view illustrating further another example of V2V performed by the collision avoidance system;

FIG. 4 is a view to describe a first application of the embodiment;

FIG. 5 is a view to describe a second application of the embodiment;

FIG. 6 is a view to describe a collision determination process to be performed in the second application;

FIG. 7 is a view to describe a third application of the embodiment;

FIG. 8 is a view to describe a collision determination process to be performed in the third application;

FIG. 9 is a view to describe a fourth application of the embodiment;

FIG. 10 is a view to describe a fifth application of the embodiment;

FIG. 11 is a block diagram illustrating an exemplary configuration of a collision avoidance system according to an embodiment;

FIG. 12 is a flowchart to describe a procedure of a travel support control process to be performed by a control device of a first vehicle; and

FIG. 13 is a flowchart to describe a procedure of a process to be performed when a control device of a second vehicle acquires V2V information.

### DETAILED DESCRIPTION OF EMBODIMENTS

With reference to the following drawings, the following describes a collision avoidance system and a collision avoidance method according to an embodiment of the present disclosure. Note that the collision avoidance method according to the embodiment is implemented by computer processing to be performed in the collision avoidance system according to the embodiment. Further, the same or equivalent portions in the drawings have the same sign and descriptions thereof are simplified or omitted.

### 1. SUMMARY OF DISCLOSURE

1-1. V2V

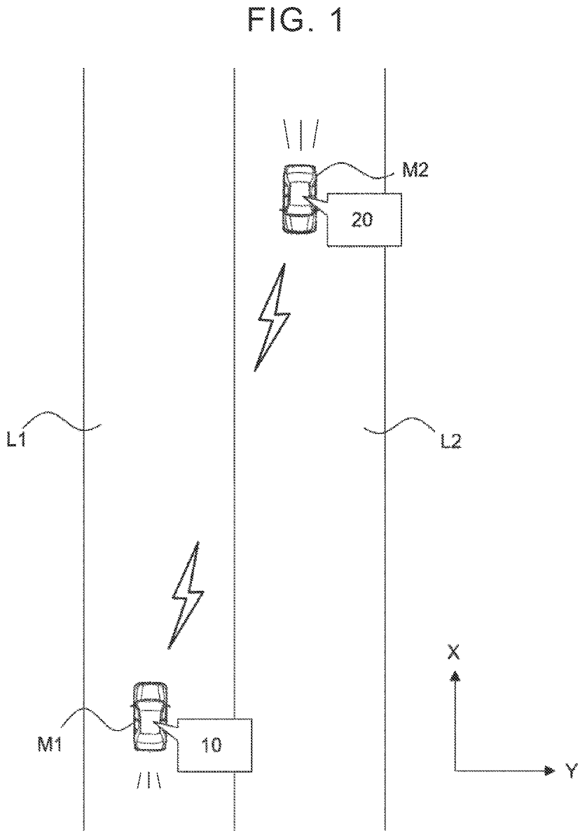

FIG. 1 is a view illustrating an example of V2V performed by a collision avoidance system according to an embodiment. In FIG. 1, a first vehicle M1 traveling on a lane L1 and a second vehicle M2 traveling on a lane L2 are illustrated. The second vehicle M2 is an oncoming vehicle traveling in the opposite direction to the advancing direction of the first vehicle M1. Here, an X-direction illustrated in FIG. 1 is the advancing direction of the first vehicle M1, and a Y-direction is a planer direction perpendicular to the X-direction. However, the coordinate system (X,Y) is not limited to this example. A control system 10 is provided in the first vehicle M1. A control system 20 is provided in the second vehicle M2. The control system 10 and the control system 20 constitute the collision avoidance system according to the embodiment.

The control system 10 and the control system 20 are configured to be communicable with each other. In the communication between the control system 10 and the control system 20, various pieces of V2V information are exchanged. The V2V information is, for example, identification information (hereinafter also referred to as “ID information”) on the first vehicle M1 and the second vehicle M2. Upon receipt of ID information on the second vehicle M2, the first vehicle M1 recognizes the second vehicle M2 as a vehicle with which V2V is performable. Upon receipt of ID information on the first vehicle M1, the second vehicle M2 recognizes the first vehicle M1 as a vehicle with which V2V is performable.

The V2V information may include travel state information on the first vehicle M1 and the second vehicle M2. The travel state information is, for example, speed information, advancing direction information, and position information. The position information is, for example, constituted by latitude-longitude information. The first vehicle M1 may receive travel state information on the second vehicle M2. In a case where the first vehicle M1 includes map information, the first vehicle M1 recognizes a specific travel state of the second vehicle M2 by combining the map information with the travel state information on the second vehicle M2. The specific travel state is, for example, a lane on which the second vehicle M2 is currently traveling, a distance from the first vehicle M1 to the second vehicle M2, and a relative speed of the first vehicle M1 to the second vehicle M2. The second vehicle M2 may receive travel state information on the first vehicle M1. In a case where the second vehicle M2 includes map information, the second vehicle M2 recognizes a specific travel state of the first vehicle M1.

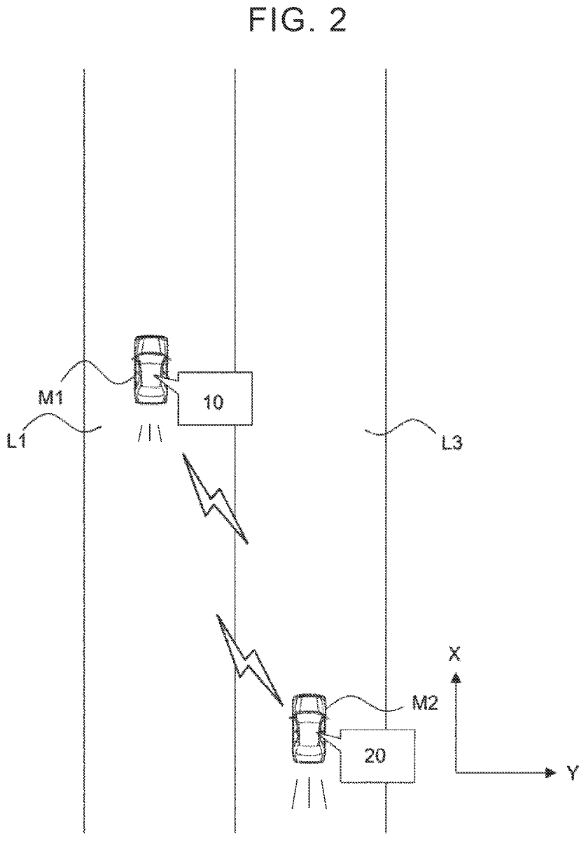

FIG. 2 is a view illustrating another example of V2V performed by the collision avoidance system according to the embodiment. In FIG. 2, the first vehicle M1 traveling on the lane L1 and the second vehicle M2 traveling on a lane L3 are illustrated. The second vehicle M2 is a side-by-side travel vehicle advancing in the same direction as the advancing direction of the first vehicle M1. The control systems 10, 20 are as described with reference to FIG. 1.

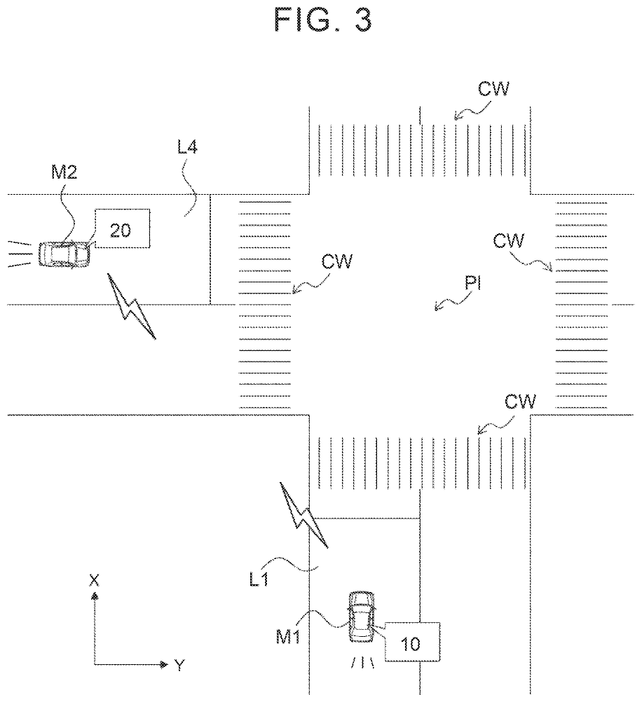

FIG. 3 is a view illustrating further another example of V2V performed by the collision avoidance system according to the embodiment. In FIG. 3, the first vehicle M1 traveling on the lane L1 and the second vehicle M2 traveling on a lane L4 are illustrated. The lane L1 and the lane L4 intersect with each other at an intersection PI. Zebra zones CW are provided around the intersection PI. The second vehicle M2 is a vehicle advancing from the left side to the right side ahead of the first vehicle M1. The control systems 10, 20 are as described with reference to FIG. 1.

1-2. Feature of Disclosure

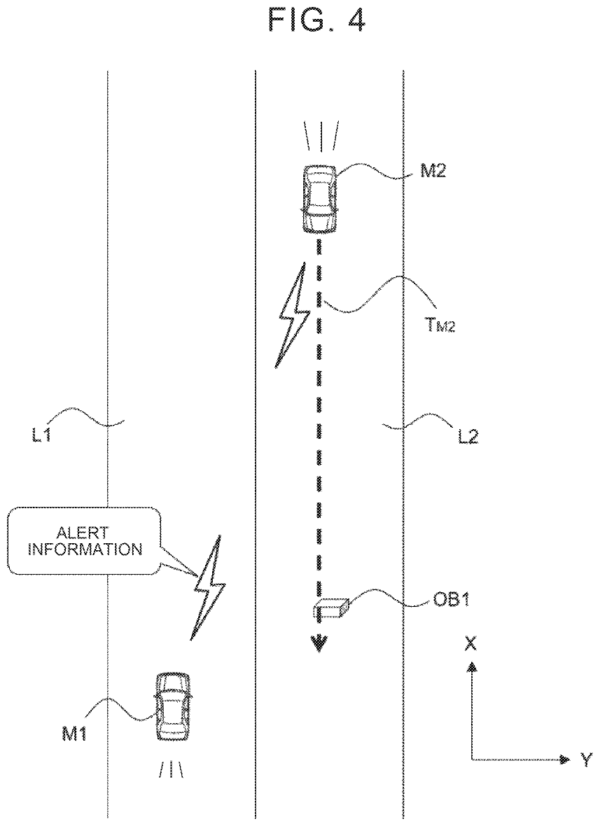

FIG. 4 is a view to describe a first application of the embodiment. In FIG. 4, an object OB1 is illustrated in addition to the first vehicle M1 and the second vehicle M2 illustrated in FIG. 1. The object OB1 is a static object present on the lane L2, for example. The object OB1 is recognized at least by the control system 10. The object OB1 is recognized by an external sensor (a sensor, a camera, or the like) included in the control system 10. Recognition information on the object OB1 is, for example, position information and speed information on the object OB1. Note that the recognition information on the object OB1 is included in “driving environment information” on the first vehicle M1.

In the present disclosure, when the control system 10 acquires the recognition information on the object OB1, “alert information” for the object OB1 is transmitted to the control system 20 as V2V information. The transmission of the alert information is not performed every time when the recognition information on the object OB1 is acquired. That is, the transmission of the alert information is performed only when the second vehicle M2 is determined to have a collision risk to collide with the object OB1 as a result of a “collision determination process” performed in the control system 10. The alert information is, for example, the recognition information on the object OB1.

The collision determination process is performed as follows, for example. First, based on the position information on the second vehicle M2 and the map information, a lane (that is, the lane L2) where the second vehicle M2 is currently traveling is specified. The position information on the second vehicle M2 is included in the in the “driving environment information” on the first vehicle M1. Further, based on a history of advancing direction information on the second vehicle M2 and a history of the position information on the second vehicle M2, a future trajectory T_{M2} of the second vehicle M2 is predicted. In a case where the advancing direction information and the position information on the second vehicle M2 are acquired by V2V, the specification of the lane and the prediction of the future trajectory T_{M2} may be performed by use of these pieces of information.

Based on the position information on the object OB1, it is found that the object OB1 is present on the lane L2. In view of this, in the collision determination process, based on the position information on the object OB1 and the future trajectory T_{M2}, it is determined whether or not the future trajectory T_{M2} passes the position of the object OB1. In a case where the future trajectory T_{M2} is determined to pass the position of the object OB1, a time-to-collision (TTC) of the second vehicle M2 to the position of the object OB1 is calculated. The calculation of the TTC is performed by use of, for example, the position information on the object OB1, the position information on the second vehicle M2, and speed information on the second vehicle M2. When the TTC is a threshold TH or less, the second vehicle M2 is determined to have a collision risk. Then, the transmission of the alert information is performed.

As has been described earlier, the alert information includes the recognition information on the object OB1. On that account, in a case where the control system 20 does not recognize the object OB1, the control system 20 can make use of the alert information for recognition of the object OB1. In a case where the control system 20 has already recognized the object OB1, the control system 20 can verify recognition information on the object OB1 recognized by the control system 20, based on the recognition information on the object OB1 that is received from the control system 10.

The alert information may include information on a target deceleration for the second vehicle M2 as emergency control information. The first vehicle M1 and the second vehicle M2 are configured to select setting on whether or not they accept emergency control information received by V2V. In a case where the second vehicle M2 is set to accept emergency control information, the control system 20 may perform an emergency deceleration control on the second vehicle M2 based on the information on the target deceleration. When the emergency deceleration control on the second vehicle M2 is performed, it is possible to avoid a collision between the second vehicle M2 and the object OB1.

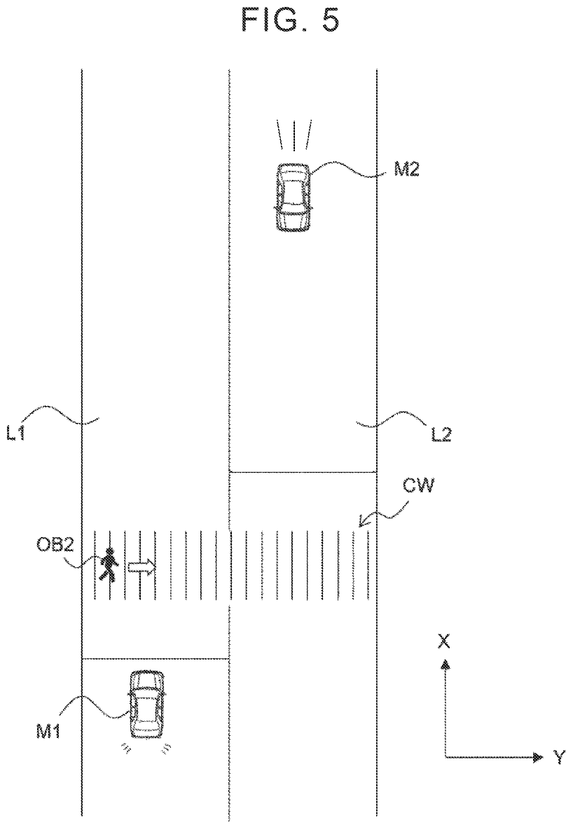

FIG. 5 is a view to describe a second application of the embodiment. In FIG. 5, an object OB2 is illustrated in addition to the first vehicle M1 and the second vehicle M2 illustrated in FIG. 1. The object OB2 is a dynamic object (pedestrian) passing a zebra zone CW, for example. The object OB2 is recognized at least by the control system 10. Recognition information on the object OB2 is, for example, speed information, advancing direction information, and position information on the object OB2. Note that the recognition information on the object OB2 is included in the “driving environment information” on the first vehicle M1.

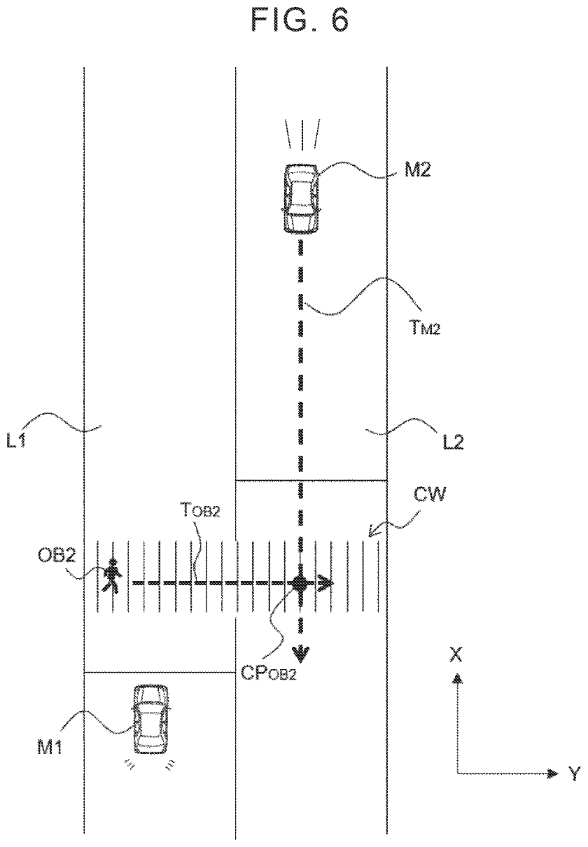

Similarly to the first application, a collision determination process is performed in the second application. FIG. 6 is a view to describe the collision determination process to be performed in the second application. The collision determination process is performed as follows, for example. First, based on the position information on the second vehicle M2 and the map information, a lane (that is, the lane L2) where the second vehicle M2 is currently traveling is specified. Further, based on a history of the advancing direction information on the second vehicle M2 and a history of the position information on the second vehicle M2, the future trajectory T_{M2} is predicted. The procedure so far is similar to the example described with reference to FIG. 4.

In the collision determination process illustrated in FIG. 6, a future trajectory T_{OB2} of the object OB2 is further predicted. The prediction of the future trajectory T_{OB2} is predicted, for example, based on a history of the advancing direction information on the object OB2 and a history of the position information on the object OB2.

In the collision determination process, based on the future trajectory T_{OB2} and the future trajectory T_{M2}, it is determined whether the future trajectories intersect with each other. For example, when a position (hereinafter also referred to as an “intersection position CP_{OB2}”) at which the distance between the future trajectory T_{OB2} and the future trajectory T_{M2} in a lateral direction (the Y-direction) is a predetermined distance or less is present, the future trajectories are determined to intersect with each other. When the future trajectories are determined to intersect with each other, a TTC of the second vehicle M2 to the intersection position CP_{OB2} is calculated. The calculation of the TTC is performed, for example, by use of the intersection position CP_{OB2}, the position information on the second vehicle M2, and the speed information on the second vehicle M2. When the TTC is a threshold TH or less, the second vehicle M2 is determined to have a collision risk. Then, transmission of alert information is performed.

In a case where the control system 20 does not recognize the object OB2, the control system 20 can make use of the alert information for recognition of the object OB2. In a case where the control system 20 has already recognized the object OB2, the control system 20 can verify recognition information on the object OB2 recognized by the control system 20, based on the recognition information on the object OB2 that is received from the control system 10. As has been described with reference to FIG. 4, the alert information may include the information on the target deceleration for the second vehicle M2.

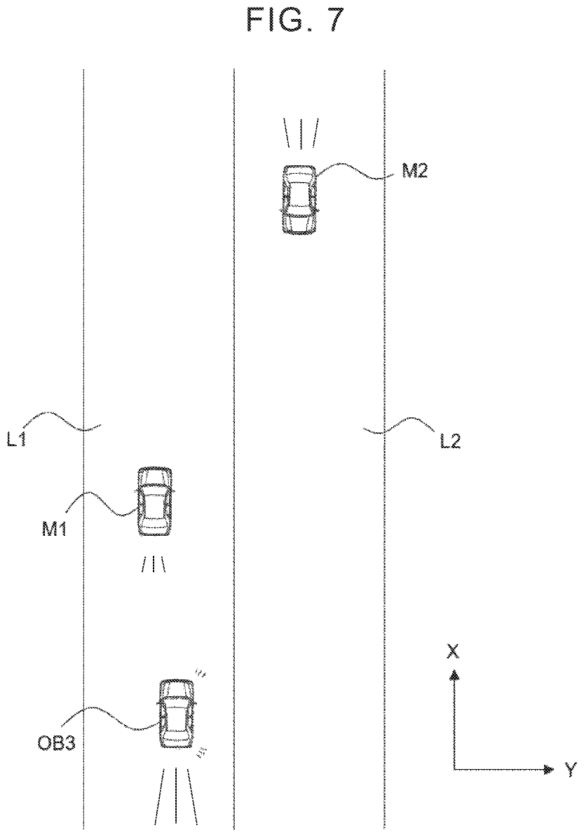

FIG. 7 is a view to describe a third application of the embodiment. In FIG. 7, an object OB3 is illustrated in addition to the first vehicle M1 and the second vehicle M2 illustrated in FIG. 1. The object OB3 is a dynamic object (a following vehicle) advancing in the same direction as the advancing direction of the first vehicle M1 behind the first vehicle M1, for example. The object OB3 is recognized at least by the control system 10. Recognition information on the object OB3 is, for example, speed information, advancing direction information, and position information on the object OB3. Note that the recognition information on the object OB3 is included in the “driving environment information” on the first vehicle M1.

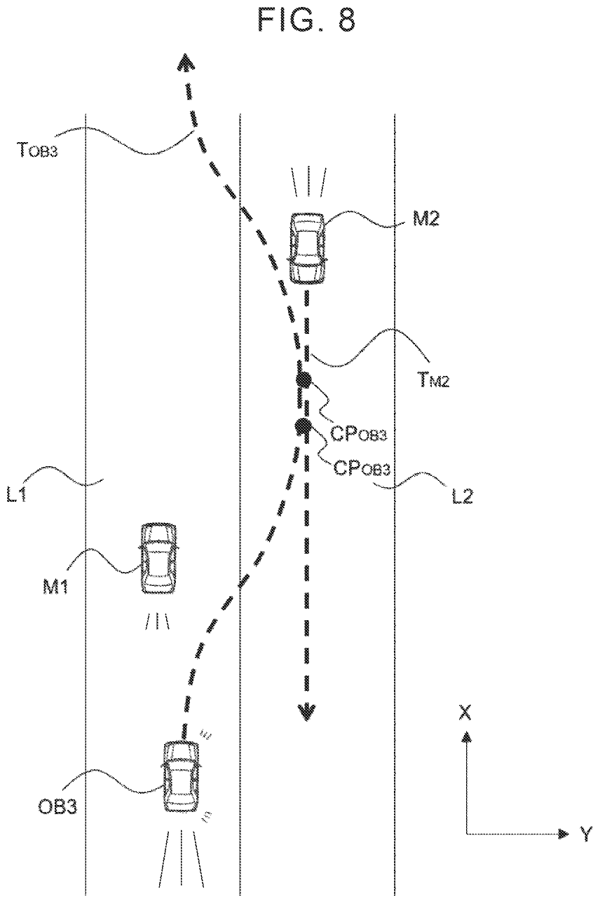

In the third application, a collision determination process is performed similarly to the first and second applications. FIG. 8 is a view to describe a collision determination process to be performed in the third application. The collision determination process is performed as follows, for example. First, based on the position information on the second vehicle M2 and the map information, a lane (that is, the lane L2) where the second vehicle M2 is currently traveling is specified. Further, based on a history of the advancing direction information on the second vehicle M2 and a history of the position information on the second vehicle M2, the future trajectory T_{M2} is predicted. The procedure so far is similar to the example described with reference to FIG. 4.

In the collision determination process illustrated in FIG. 8, a future trajectory T_{OB3} of the object OB3 is further predicted. The future trajectory T_{OB3} is predicted when lighting of a turn signal lamp (blinker), on the lane L2 side, of the object OB3 is recognized by the control system 10. Alternatively, when a speed change amount of the object OB3 directed from the lane L1 to the lane L2 in the lateral direction (Y-direction) is a predetermined amount or more, the future trajectory T_{OB3} is predicted. That is, the future trajectory T_{OB3} is predicted only when a passing operation of the object OB3 to pass the first vehicle M1 is recognized or predicted by the control system 10. The future trajectory T_{OB3} is predicted based on the speed information on the object OB3, the position information on the object OB3, and a trajectory for the passing operation, the trajectory being set in advance.

The trajectory for the passing operation is, for example, a trajectory obtained by combining a trajectory for lane-changing from the lane L1 to the lane L2 and a trajectory for lane-changing from the lane L2 to the lane L1. The length of the trajectory for the passing operation in the advancing direction (the X-direction) is changed in accordance with the speed information on the object OB3.

In the collision determination process, it is determined whether the future trajectories intersect with each other or not, based on the future trajectory T_{OB3} and the future trajectory T_{M2}. For example, when a position (hereinafter also referred to as an “intersection position CP_{OB3}”) at which the distance between the future trajectory T_{OB3} and the future trajectory T_{M2} in the lateral direction (the Y-direction) is a predetermined distance or less is present, the future trajectories are determined to intersect with each other. When the future trajectories are determined to intersect with each other, a TTC of the second vehicle M2 to the intersection position CP_{OB3} is calculated. The calculation of the TTC is performed by use of, for example, the intersection position CP_{OB3}, the position information on the second vehicle M2, and the speed information on the second vehicle M2.

In the example illustrated in FIG. 8, two intersection positions CP_{OB3} are illustrated. This is because the future trajectory T_{OB3} is formed from the trajectory for the passing operation. In a case where two or more intersection positions CP_{OB3} are included, the intersection determination is performed for each of the intersection positions CP_{OB3}. When the TTC in any of the intersection positions CP_{OB3} is the threshold TH or less, the second vehicle M2 is determined to have a collision risk. Then, transmission of alert information is performed. The effect of the alert information is similar to those in the first and second applications.

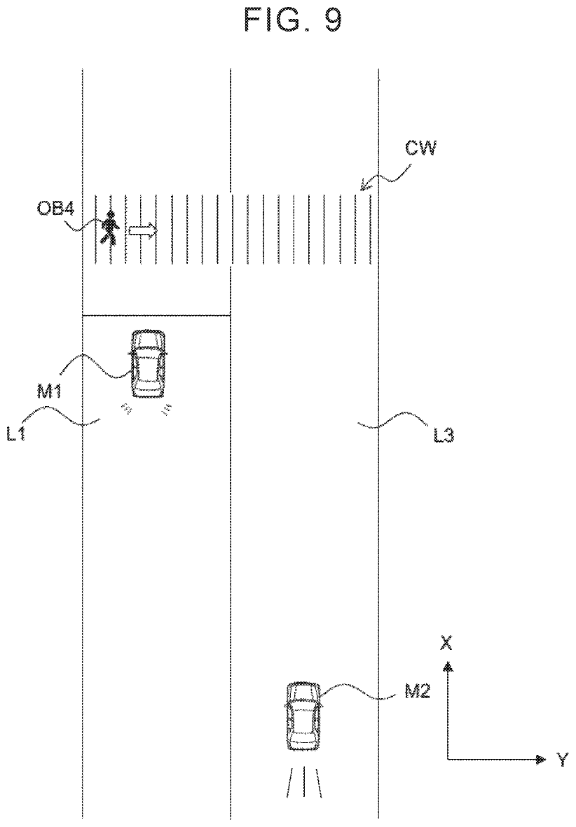

FIG. 9 is a view to describe a fourth application of the embodiment. In FIG. 9, an object OB4 is illustrated in addition to the first vehicle M1 and the second vehicle M2 illustrated in FIG. 2. The object OB4 is a dynamic object (pedestrian) passing a zebra zone CW, for example. The object OB4 is recognized at least by the control system 10. Recognition information on the object OB4 is, for example, speed information, advancing direction information, and position information on the object OB4. Note that the recognition information on the object OB4 is included in the “driving environment information” on the first vehicle M1.

In the fourth application, a collision determination process is performed similarly to the first to third applications. The content of this collision determination process is the same as that of the collision determination process described with reference to FIG. 6. That is, in the collision determination process, it is determined whether or not a future trajectory of the object OB4 and a future trajectory of the second vehicle M2 intersect with each other. When these future trajectories are determined to intersect with each other, a TTC of the second vehicle M2 to an intersection position between the trajectories is calculated. When the TTC is the threshold TH or less, the second vehicle M2 is determined to have a collision risk. Then, transmission of alert information is performed. The effect of the alert information is similar to those in the first to third applications.

Note that the example illustrated in FIG. 9 deals with a case where the distance from the object OB4 to the first vehicle M1 is shorter than the distance from the object OB4 to the second vehicle M2. However, needless to say, the embodiment is also applicable to a case where the former distance is longer than the latter distance. This is because such a case is also assumed that the second vehicle M2 cannot recognize the object OB4 for some reasons.

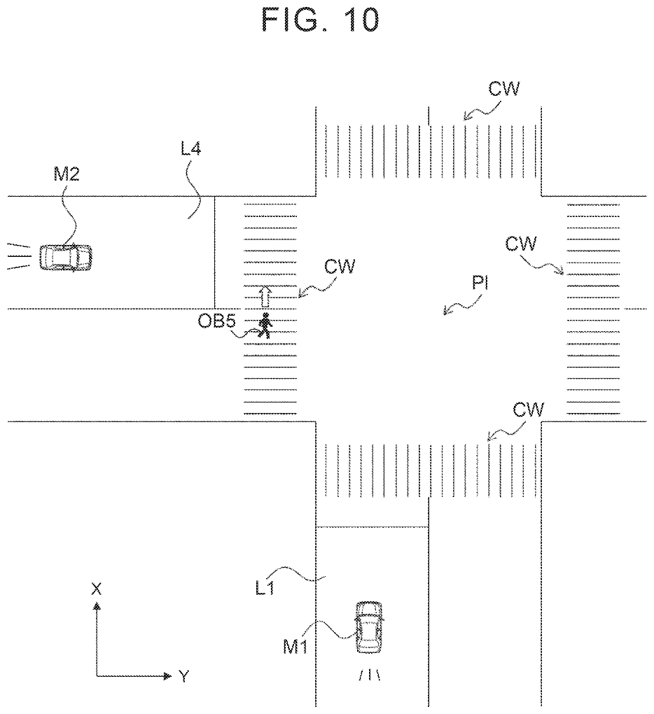

FIG. 10 is a view to describe a fifth application of the embodiment. In FIG. 10, an object OB5 is illustrated in addition to the first vehicle M1 and the second vehicle M2 illustrated in FIG. 3. The object OB5 is a dynamic object (pedestrian) passing a zebra zone CW on the lane L4, for example. The object OB5 is recognized at least by the control system 10. Recognition information on the object OB5 is, for example, speed information, advancing direction information, and position information on the object OB5. Note that the recognition information on the object OB5 is included in the “driving environment information” on the first vehicle M1.

In the fifth application, a collision determination process is also performed similarly to the first to fourth applications. The content of this collision determination process is the same as that of the collision determination process described with reference to FIG. 6.

Thus, with the collision avoidance system and the collision avoidance method according to the embodiment, traveling safety of the second vehicle M2 is improved, and as a result, traveling safety of the first vehicle M1 is improved.

Next will be described the collision avoidance system and the collision avoidance method according to the embodiment in detail.

### 2. EXEMPLARY CONFIGURATION OF COLLISION AVOIDANCE SYSTEM

2-1. Example of Overall Configuration

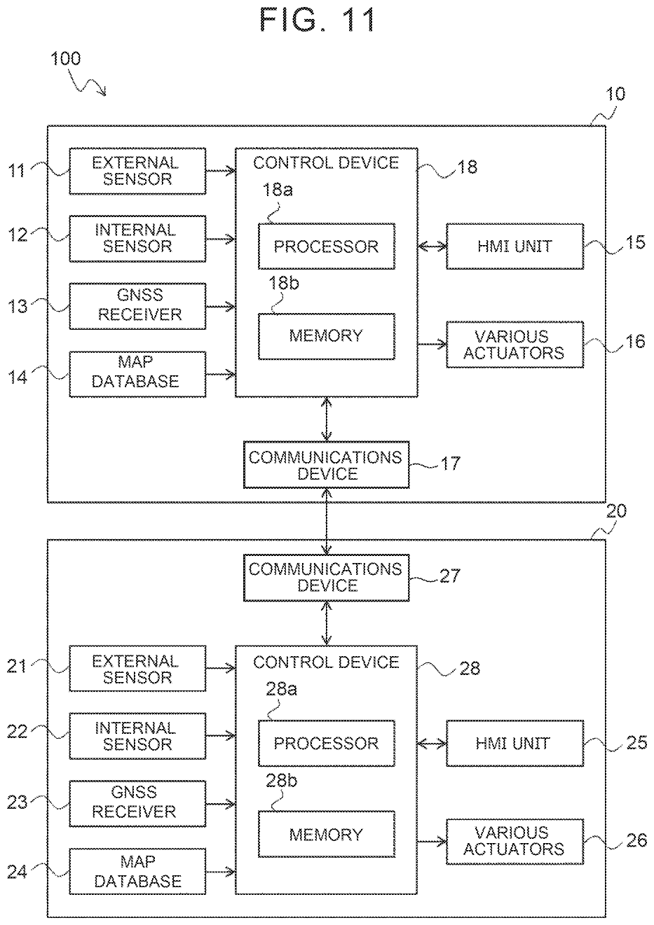

FIG. 11 is a block diagram illustrating an exemplary configuration of a collision avoidance system according to the embodiment. As illustrated in FIG. 11, a collision avoidance system 100 includes the control system 10 and the control system 20. The control system 10 is a control system provided in the first vehicle M1. The control system 20 is a control system provided in the second vehicle M2.

The control system 10 includes an external sensor 11, an internal sensor 12, a global navigation satellite system (GNSS) receiver 13, and a map database 14. Further, the control system 10 includes a human machine interface (HMI) unit 15, various actuators 16, a communications device 17, and a control device 18.

The external sensor 11 is an instrument configured to detect a state around the first vehicle M1. The external sensor 11 is, for example, a radar sensor and a camera. The radar sensor detects an object around the first vehicle M1 by use of a radio wave (e.g., millimeter wave) or light. The object includes a static object and a dynamic object. The static object is, for example, a guard rail and a building. The dynamic object includes a pedestrian, a bicycle, a motorcycle, and a vehicle other than the first vehicle M1. The camera captures an image of a state outside the first vehicle M1.

The internal sensor 12 is an instrument configured to detect a travel state of the first vehicle M1. The internal sensor 12 is, for example, a vehicle speed sensor, an acceleration sensor, and a yaw rate sensor. The vehicle speed sensor detects a traveling speed of the first vehicle M1. The acceleration sensor detects an acceleration of the first vehicle M1. The yaw rate sensor detects a yaw rate around the vertical axis of the gravitational center of the first vehicle M1.

The GNSS receiver 13 is a device configured to receive signals from three or more artificial satellites. The GNSS receiver 13 is also a device configured to acquire information on the position of the first vehicle M1. The GNSS receiver 13 calculates the position and the posture (orientation) of the first vehicle M1 based on the signals thus received.

The map database 14 is a database in which map information is stored. The map information is, for example, position information on roads, information on road shapes (e.g., types such as a curve and a straight), and position information on intersections and structural objects. The map information also includes traffic rule information. The map database 14 is formed in an in-vehicle storage device (e.g., a hard disk, a flash memory). The map database 14 may be formed in a computer in a facility (e.g., a management center) communicable with the first vehicle M1.

The information on the surrounding state that is acquired by the external sensor 11, the information on the traveling state that is acquired by the internal sensor 12, the information on the position and the posture that is acquired by the GNSS receiver 13, and the map information are included in the “driving environment information” of the first vehicle M1. That is, the external sensor 11, the internal sensor 12, the GNSS receiver 13, and the map database 14 correspond to an “acquisition device” in the present disclosure.

The HMI unit 15 is an interface configured to provide information to a driver of the first vehicle M1 and also to receive information from the driver. The HMI unit 15 includes an input device, a display device, a speaker, and a microphone, for example. The input device is, for example, a touch panel, a keyboard, a switch, and a button. The information to be provided to the driver includes travel state information on the first vehicle M1 and V2V information (e.g., ID information, travel state information, alert information). The information is provided to the driver by use of the display device and the speaker. The information is received from the driver by use of the display device and the microphone. Setting on whether or not the first vehicle M1 accepts emergency control information received by V2V is performed by the reception of the information from the driver.

The various actuators 16 are actuators provided in a travel device of the first vehicle M1. The various actuators 16 include a drive actuator, a brake actuator, and a steering actuator. The drive actuator drives the first vehicle M1. The brake actuator gives braking force to the first vehicle M1. The steering actuator steers wheels of the first vehicle M1.

The communications device 17 includes a transmitting antenna and a receiving antenna configured to communicate wirelessly with a vehicle (e.g., a vehicle ahead of or behind the first vehicle M1) around the first vehicle M1. The wireless communication is performed, for example, by use of directional beams including narrow beams formed by directional transmitting antennas. In a case where V2V is performed by use of narrow beams, a synchronization system configured to perform beam alignment by use of a pilot signal may be used. The frequency of the wireless communication may be also several hundreds MHz lower than 1 GHz or may be a high frequency band of 1 GHz or more, for example.

In a case where V2V is performed by use of narrow beams, the beams may be synchronized with each other by use of a pilot signal. For example, the first vehicle M1 transmits a pilot signal to a surrounding vehicle, and the surrounding vehicle detects the pilot signal for a narrow beam by a wide beam mode or a non-directional beam mode and adjusts the direction of the narrow beam of the surrounding vehicle based on the detection result.

The control device 18 is constituted by a microcomputer including at least one processor 18a and at least one memory 18b. In the memory 18b, at least one program is stored. Various pieces of information including driving environment information are also stored in the memory 18b. When the program stored in the memory 18b is read out and executed by the processor 18a, various functions of the control device 18 are implemented. The functions also include a function of the collision determination process described above. The functions also include a function to perform a traveling control on the first vehicle M1 by use of the various actuators 16.

The control system 20 includes an external sensor 21, an internal sensor 22, a GNSS receiver 23, and a map database 24. Further, the control system 20 includes an HMI unit 25, various actuators 26, a communications device 27, and a control device 28. That is, the basic configuration of the control system 20 is common with that of the control system 10. Accordingly, see the descriptions about the control system 10 in terms of examples of individual constituents of the control system 20.

Note that the configuration of the control system 20 is not limited to the example illustrated in FIG. 11, and some constituents may be omitted. For example, the control system 20 may not include the external sensor 21, the internal sensor 22, the GNSS receiver 23, and the map database 24.

2-2. Exemplary Process in Control System 10

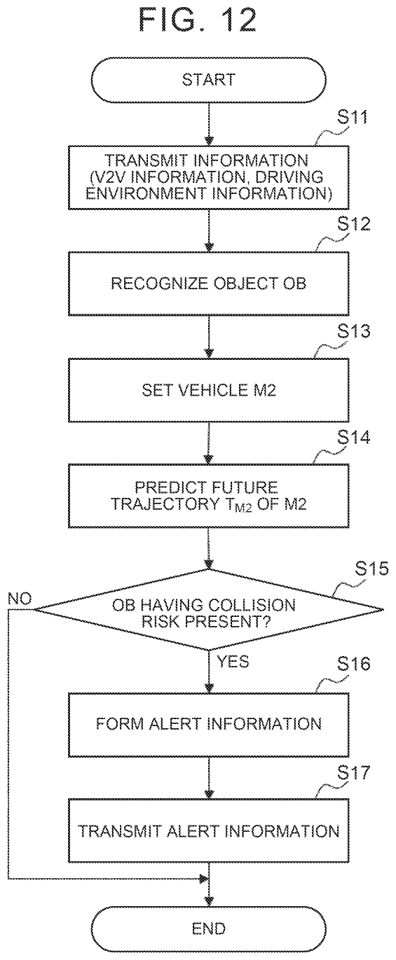

FIG. 12 is a flowchart to describe a procedure of a collision determination process to be performed by the control device 18 (the processor 18a). The routine illustrated in FIG. 12 is executed repeatedly at a predetermined control cycle.

In the routine illustrated in FIG. 12, various pieces of information are acquired first (step S11). The various pieces of information to be acquired are, for example, V2V information and driving environment information. The V2V information is, for example, ID information on the second vehicle M2. The V2V information may include travel state information on the second vehicle M2. The driving environment information includes information on the surrounding state to be acquired by the external sensor 11, information on the traveling state to be acquired by the internal sensor 12, information on the position and the posture of the first vehicle M1 to be acquired by the GNSS receiver 13, and map information from the map database 14.

Subsequently to the process of step S11, recognition of objects OB around the first vehicle M1 is performed (step S12). The recognition of the objects OB is performed mainly based on the information on the surrounding state to be provided from the external sensor 11, the information on the position and the posture of the first vehicle M1, and the map information. At the time of recognition of the objects OB, recognition information on the objects OB (more specifically, speed information, advancing direction information, and position information on the objects OB) is calculated.

Subsequently to the process of step S12, the second vehicle M2 is set (step S13). The setting of the second vehicle M2 is performed by selecting a vehicle recognized as a vehicle that can perform V2V and an oncoming vehicle from the objects OB recognized in step S11, for example. The total number of the second vehicles M2 to be set is at least one.

Subsequently to the process of step S13, the future trajectory T_{M2} of the second vehicle M2 is predicted (step S14). The future trajectory T_{M2} is predicted, for example, based on a history of advancing direction information on the second vehicle M2 and a history of position information on the second vehicle M2.

Subsequently to the process of step S14, it is determined whether an object OB having a collision risk to collide with the second vehicle M2 is present or not (step S15). The content of the process of step S15 changes in accordance with the types of the objects OB recognized in step S11.

In a case where the object OB is a static object (see FIG. 4), it is determined whether the future trajectory T_{M2} passes the position of the object OB or not, based on position information on the object OB and the future trajectory T_{M2}. In a case where the future trajectory T_{M2} is determined to pass the position of the object OB, a TTC of the second vehicle M2 to the position of the object OB is calculated. When the TTC is the threshold TH or less, the second vehicle M2 is determined to have a collision risk. When the future trajectory T_{M2} is determined not to pass the position of the object OB, the second vehicle M2 is determined not to have a collision risk. When the TTC is the threshold TH or more, the second vehicle M2 is also determined not to have a collision risk.

In a case where the object OB is a dynamic object (see FIGS. 5, 6, 9, 10), a future trajectory TUB of the dynamic object is first predicted. The future trajectory TUB is predicted, for example, based on a history of advancing direction information on the object OB and a history of position information on the object OB. Subsequently, it is determined whether a position (hereinafter also referred to as an “intersection position CP_{OB}”) at which the distance between the future trajectory TUB and the future trajectory T_{M2} in the lateral direction (the Y-direction) is a predetermined distance or less is present or not. When the intersection position CP_{OB} is determined to be present, a TTC of the second vehicle M2 to the intersection position CP_{OB} is calculated. When the TTC is the threshold TH or less, the second vehicle M2 is determined to have a collision risk. When the intersection position CP_{OB} is determined not to be present, the second vehicle M2 is determined not to have a collision risk. When the TTC is the threshold TH or more, the second vehicle M2 is also determined not to have a collision risk.

In a case where the object OB is a following vehicle (see FIGS. 7, 8), first, it is determined whether or not a passing operation of the following vehicle to pass the first vehicle M1 is recognized or predicted. When the passing operation is determined to be recognized or predicted, a future trajectory TUB of the following vehicle is predicted. The future trajectory TUB is predicted, for example, based on position information on the following vehicle, speed information on the following vehicle, and a trajectory for the passing operation. Subsequently, it is determined whether the intersection position CP_{OB} is present or not. The content of the determination is the same as that of the determination performed in a case where the object OB is a dynamic object (see FIG. 6).

In a case where a determination result in step S15 is affirmative, alert information is formed (step S16). The alert information is, for example, recognition information on the object OB determined to have a collision risk to collide with the second vehicle M2 in step S15. The alert information may include information on a target deceleration for the second vehicle M2 as emergency control information. The target deceleration for the second vehicle M2 is a target value of a deceleration to stop the second vehicle M2 just before the position of the object OB (see FIG. 4) or the intersection position CP_{OB} (see FIG. 6).

Subsequently to the process of step S16, the alert information is transmitted (step S17). In the process of step S17, the alert information formed in the process of step S16 is transmitted to the communications device 17. The alert information transmitted to the communications device 17 is transmitted to the communications device 27 as V2V information.

2-3. Exemplary Process of Control System 20

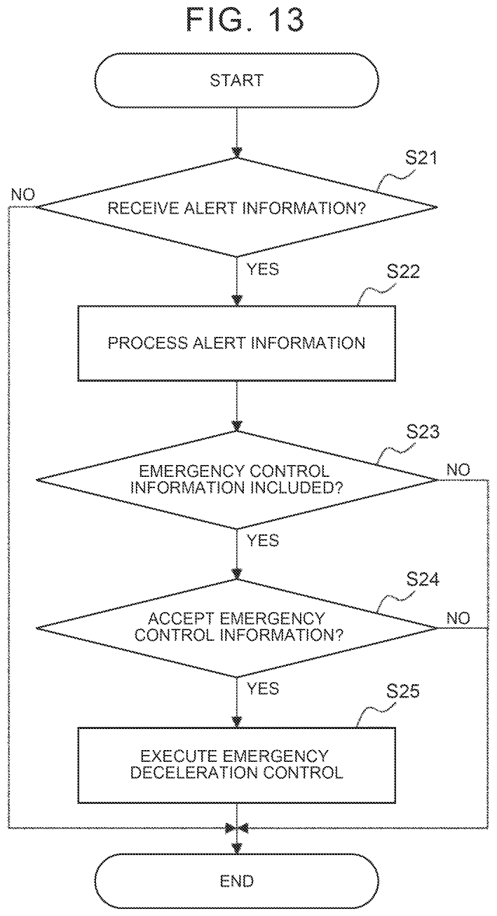

FIG. 13 is a flowchart to describe a procedure of a process to be performed when the control device 28 (a processor 28a) acquires V2V information. The routine illustrated in FIG. 13 is executed repeatedly at a predetermined control cycle.

In the routine illustrated in FIG. 13, first, it is determined whether alert information is received as V2V information or not (step S21). As has been described earlier, the alert information includes recognition information on the object OB having a collision risk to collide with the second vehicle M2.

In a case where a determination result in step S21 is affirmative, a process on the alert information is performed (step S22). In the process of step S22, position information on the object OB that is received in the process of step S21 is fused with surrounding state information acquired by the external sensor 21, for example. Due to this fusion process, the object OB received in the process of step S21 is recognized by the control system 20. In a case where the control system 20 has recognized the object OB1, recognition information on the object OB1 recognized by the control system 20 may be verified based on the position information on the object OB that is received in the process of step S21.

In the process of step S22, a process to output alert information from the HMI unit 25 may be performed. In a case where the position information on the object OB is included in the alert information, for example, a process to output the position information from the HMI unit 25 may be performed.

Subsequently to the process of step S22, it is determined whether or not emergency control information is included in the alert information (step S23). In a case where a determination result in step S23 is affirmative, it is determined whether or not the emergency control information is to be accepted or not (step S24). The process of step S24 is determined based on whether the emergency control information is set to be accepted or not.

In a case where a determination result in step S24 is affirmative, the emergency deceleration control is executed (step S25). In the process of step S25, a brake actuator of the second vehicle M2 is controlled based on the target deceleration as the emergency control information.

### 3. EFFECTS

With the collision avoidance system and the collision avoidance method according to the embodiment described above, the first vehicle M1 (the control system 10) determines whether the object OB having a collision risk to collide with the second vehicle M2 is present or not. In a case where the object OB having a collision risk is present, alert information on the object OB is provided to the second vehicle M2 (the control system 20) from the first vehicle M1 (the control system 10). This can improve traveling safety of the second vehicle M2, and as a result, traveling safety of the first vehicle M1 can be improved.

What is claimed is:

1. A collision avoidance system using communication between a first vehicle and a second vehicle, wherein:
the first vehicle includes
a communications device configured to transmit and receive vehicle-to-vehicle communication information,
an acquisition device configured to acquire driving environment information on the first vehicle, and
a processing device configured to perform a collision determination process for the second vehicle;
the second vehicle includes a communications device configured to transmit and receive vehicle-to-vehicle communication information;
the collision determination process is performed as follows,
the processing device recognizes an object around the first vehicle based on the driving environment information,
the processing device determines whether or not the second vehicle has a collision risk to collide with the object, based on the driving environment information and the vehicle-to-vehicle communication information received from the second vehicle, and
when the processing device determines that the second vehicle has the collision risk, the processing device transmits alert information for the object to the communications device of the second vehicle via the communications device of the first vehicle.

2. The collision avoidance system according to claim 1, wherein:
the second vehicle further includes a control device configured to perform a travel control on the second vehicle;
the alert information includes information on a target deceleration for the second vehicle to avoid a collision with the object; and
the control device performs an emergency deceleration control on the second vehicle based on the target deceleration as the travel control.

3. The collision avoidance system according to claim 1, wherein the collision determination process is performed as follows:
the processing device recognizes a static object on a lane where the second vehicle is traveling, based on the driving environment information;
based on at least either of the driving environment information and the vehicle-to-vehicle communication information received from the second vehicle, the processing device predicts a future trajectory of the second vehicle and determines whether or not the future trajectory passes a recognized position of the static object;
when the processing device determines that the future trajectory passes the recognized position, the processing device calculates a time-to-collision of the second vehicle to the recognized position; and
when the time-to-collision is a threshold or less, the processing device determines that the second vehicle has the collision risk.

4. The collision avoidance system according to claim 1, wherein the collision determination process is performed as follows:
the processing device recognizes a dynamic object on a lane where the second vehicle is traveling or outside the lane, based on the driving environment information;
based on at least either of the driving environment information and the vehicle-to-vehicle communication information received from the second vehicle, the processing device predicts future trajectories of the dynamic object and the second vehicle and determines whether the future trajectories intersect with each other or not;
when the processing device determines that the future trajectories intersect with each other, the processing device calculates a time-to-collision of the second vehicle to an intersection position between the future trajectories; and
when the time-to-collision is a threshold or less, the processing device determines that the second vehicle has the collision risk.

5. A collision avoidance method using communication between a first vehicle and a second vehicle, the second vehicle being an oncoming vehicle traveling ahead of the first vehicle in a direction opposite to an advancing direction of the first vehicle, the collision avoidance method comprising:
acquiring, by a processing device of the first vehicle, driving environment information on the first vehicle;
recognizing, by the processing device, an object around the first vehicle based on the driving environment information;
determining, by the processing device, whether or not the second vehicle has a collision risk to collide with the object, based on the driving environment information and vehicle-to-vehicle communication information received from the second vehicle; and
when the processing device determines that the second vehicle has the collision risk, transmitting, by the processing device, alert information for the object to a communications device of the second vehicle via a communication device of the first vehicle.
